(19) United States
(12) Patent Application Publication
(10) Pub. No.: US 2013/0298889 A1
(43) Pub. Date: Nov. 14, 2013

(54) OUTWARDLY-OPENING VALVE WITH CAST-IN DIFFUSER

(71) Applicants: FORD A. PHILLIPS, SAN ANTONIO, TX (US); CHRISTOPHER L. WRAY, SAN ANTONIO, TX (US); MITCHEL A. SMOLIK, HOUSTON, TX (US)

(72) Inventors: FORD A. PHILLIPS, SAN ANTONIO, TX (US); CHRISTOPHER L. WRAY, SAN ANTONIO, TX (US); MITCHEL A. SMOLIK, HOUSTON, TX (US)

(73) Assignee: SCUDERI GROUP, INC., WEST SPRINGFIELD, MA (US)

(21) Appl. No.: 13/886,301

(22) Filed: May 3, 2013

Related U.S. Application Data
(60) Provisional application No. 61/644,471, filed on May 9, 2012.

(51) Int. Cl. F02B 33/22

(52) U.S. Cl. CPC F02B 33/22
USPC 123/70 R; 123/188.1

(57) ABSTRACT

Disclosed is an engine valve port including a valve opening, a first portion, and a separate second portion. The first portion and the second portion are separately connected to the valve opening, and the first portion and the second portion merge together at a location spaced from the valve opening. The valve port has a bifurcated, porpoise-like shape. The first portion and the second portion are generally arcuate in shape, and the first portion and the second portion have a generally semicircular cross-section. Also disclosed is an engine including such a valve port. A valve associated with the valve port may be an outwardly-opening valve.

### CROSS-REFERENCE TO RELATED APPLICATION

This application claims the priority of U.S. Provisional Application No. 61/644,471 filed May 9, 2012.

### TECHNICAL FIELD

The present invention relates to internal combustion engines. More specifically, the present invention relates to a split-cycle engine having a pair of pistons in which one piston is used for the intake and compression strokes and another piston is used for the expansion (or power) and exhaust strokes, with each of the four strokes being completed in one revolution of the crankshaft.

### BACKGROUND OF THE INVENTION

For purposes of clarity, the term “conventional engine” as used in the present application refers to an internal combustion engine wherein all four strokes of the well-known Otto cycle (the intake, compression, expansion and exhaust strokes) are contained in each piston/cylinder combination of the engine. Each stroke requires one half revolution of the crankshaft (180 degrees crank angle (CA)), and two full revolutions of the crankshaft (720 degrees CA) are required to complete the entire Otto cycle in each cylinder of a conventional engine.

Also, for purposes of clarity, the following definition is offered for the term “split-cycle engine” as may be applied to engines disclosed in the prior art and as referred to in the present application.

A split-cycle engine comprises:

a crankshaft rotatable about a crankshaft axis;

a compression piston slidably received within a compression cylinder and operatively connected to the crankshaft such that the compression piston reciprocates through an intake stroke and a compression stroke during a single rotation of the crankshaft;

an expansion (power) piston slidably received within an expansion cylinder and operatively connected to the crankshaft such that the expansion piston reciprocates through an expansion stroke and an exhaust stroke during a single rotation of the crankshaft; and

a crossover passage interconnecting the compression and expansion cylinders, the crossover passage including at least a crossover expansion (XovrE) valve disposed therein, but more preferably including a crossover compression (XovrC) valve and a crossover expansion (XovrE) valve defining a pressure chamber therebetween.

U.S. Pat. No. 6,543,225 granted Apr. 8, 2003 to Carmelo J. Scuderi (the Scuderi patent) and U.S. Pat. No. 6,952,923 granted Oct. 11, 2005 to David P. Branyon et al. (the Branyon patent) each contains an extensive discussion of split-cycle and similar type engines. In addition, the Scuderi and Branyon patents disclose details of prior versions of engines of which the present invention comprises a further development. Both the Scuderi patent and the Branyon patent are incorporated herein by reference in their entirety.

Referring to FIGS. 1 and 2, a prior art split-cycle engine of the type similar to those described in the Branyon and Scuderi patents is shown generally by numeral 10. The split-cycle engine 10 replaces two adjacent cylinders of a conventional engine with a combination of one compression cylinder 12 and one expansion cylinder 14. A cylinder head 33 is typically disposed over an open end of the compression and expansion cylinders 12, 14 to cover and seal the cylinders.

The cylinder head 33 provides the structure for gas flow into, out of and between the cylinders 12, 14. In the order of gas flow, the cylinder head includes an intake port 19 through which intake air is drawn into the compression cylinder 12, a crossover (Xovr) passage (or port) 22 through which compressed air is transferred from the compression cylinder 12 to the expansion cylinder 14, and an exhaust port 35 through which spent gases are discharged from the expansion cylinder.

The four strokes of the Otto cycle are “split” over the two cylinders 12 and 14 such that the compression cylinder 12, together with its associated compression piston 20, perform the intake and compression strokes, and the expansion cylinder 14, together with its associated expansion piston 30, perform the expansion and exhaust strokes. The Otto cycle is therefore completed in these two cylinders 12, 14 once per crankshaft 16 revolution (360 degrees CA) about crankshaft axis 17.

With the split-cycle engine concept, the geometric engine parameters (i.e., bore, stroke, connecting rod length, volumetric compression ratio, etc.) of the compression 12 and expansion 14 cylinders are generally independent from one another. For example, the crank throws 36, 37 for the compression cylinder 12 and expansion cylinder 14, respectively, may have different radii and may be phased apart from one another such that top dead center (TDC) of the expansion piston 30 occurs prior to TDC of the compression piston 20. This independence enables the split-cycle engine 10 to potentially achieve higher efficiency levels and greater torques than typical four-stroke engines. In this embodiment the expansion piston 30 leads the compression piston 20 by approximately 20 degrees crank angle. In other words, the compression piston 20 reaches its TDC position 20 degrees of crankshaft rotation after the expansion piston 30 reaches its TDC position. The diameters of the cylinders and pistons and the strokes of the pistons and their displacements need not be the same.

During the intake stroke, intake air is drawn into the compression cylinder 12 through the intake port 19 disposed in the cylinder head 33. An inwardly-opening (opening inwardly into the cylinder and toward the piston) poppet intake valve 18 controls fluid communication between the intake port 19 and the compression cylinder 12. The intake air is at atmospheric pressure.

During the compression stroke, the compression piston 20 pressurizes the air charge and drives the air charge into the crossover passage (or port) 22, which is typically disposed in the cylinder head 33. This means that the compression cylinder 12 and compression piston 20 are a source of high pressure gas to the crossover passage 22, which acts as the intake passage for the expansion cylinder 14. As shown in FIG. 2, a pair of separate crossover passages 22 interconnects the compression cylinder 12 and the expansion cylinder 14. However, the split-cycle engine 10 may include one or more than two crossover passages connecting the compression and expansion cylinder.

Due to very high compression ratios (e.g., 20 to 1, 30 to 1, 40 to 1, or greater), an outwardly-opening (opening outwardly away from the cylinder and piston) poppet crossover compression (XovrC) valve 24 at the crossover passage inlet 25 is used to control flow from the compression cylinder 12 into the crossover passage 22. Due to very high expansion ratios (e.g., 20 to 1, 30 to 1, 40 to 1, or greater), an outwardly-opening poppet crossover expansion (XovrE) valve 26 at the outlet 27 of the crossover passage 22 controls flow from the crossover passage into the expansion cylinder 14. The actuation rates and phasing of the XovrC and XovrE valves 24, are timed to maintain pressure in the crossover passage 22 at a high minimum pressure (typically 20 bar absolute or higher, e.g., 40 to 50 bar, during full load operation) during all four strokes of the Otto cycle. The valves may be actuated in any suitable manner such as by mechanically driven cams, variable valve actuation technology or the like.

At least one fuel injector 28 injects fuel into the pressurized air at the exit end of the crossover passage 22 in correspondence with the XovrE valve 26 opening, which occurs shortly before expansion piston 30 reaches its top dead center position. At this time, the pressure ratio of the pressure in crossover passage 22 to the pressure in expansion cylinder 14 is high, due to the fact that the minimum pressure in the crossover passage is typically20 bar absolute or higher at full engine load and the pressure in the expansion cylinder during the exhaust stroke is typically about one to two bar absolute. In other words, when XovrE valve opens, the pressure in crossover passage 22 is substantially higher than the pressure in expansion cylinder 14 (typically in the order of 20 to 1 or greater at full engine load). This high pressure ratio causes initial flow of the air and/or fuel charge to flow into expansion cylinder 14 at high speeds. These high flow speeds can reach the speed of sound, which is referred to as sonic flow. The air/fuel charge usually enters the expansion cylinder 14 shortly after expansion piston 30 reaches its top dead center position (TDC), although it may begin entering slightly before TDC under some operating conditions. As piston 30 begins its descent from its top dead center position, and while the XovrE valve 26 is still open, spark plug 32, which includes a spark plug tip 39 that protrudes into cylinder 14, is fired to initiate combustion in the region around the spark plug tip 39. Combustion can be initiated while the expansion piston is between 1 and 30 degrees CA past its top dead center (TDC) position. More preferably, combustion can be initiated while the expansion piston is between 5 and 25 degrees CA past its top dead center (TDC) position. Most preferably, combustion can be initiated while the expansion piston is between 10 and 20 degrees CA past its top dead center (TDC) position. Additionally, combustion may be initiated through other ignition devices and/or methods, such as with glow plugs, microwave ignition devices or through compression ignition methods. The sonic flow of the air/fuel charge is particularly advantageous to split-cycle engine 10 because it causes a rapid combustion event, which enables the split-cycle engine 10 to maintain high combustion pressures even though ignition is initiated while the expansion piston 30 is descending from its top dead center position.

The XovrE valve 26 is closed after combustion is initiated but before the resulting combustion event can enter the crossover passage 22. The combustion event drives the expansion piston 30 downward in a power stroke.

During the exhaust stroke, exhaust gases are pumped out of the expansion cylinder 14 through exhaust port 35 disposed in cylinder head 33. An inwardly-opening poppet exhaust valve 34, disposed in the inlet 31 of the exhaust port 35, controls fluid communication between the expansion cylinder 14 and the exhaust port 35.

As discussed above, to achieve maximum efficiency, the transfer of compressed air from the compression cylinder to the expansion cylinder is carried out when both the compression and expansion pistons 20, 30 are near top dead center. Traditional inwardly-opening poppet valves that open into the cylinders would interfere with the respective pistons if opened to the lift heights required to achieve necessary flow. Therefore, the XovrC valve 24 and XovrE valve 26 are outwardly-opening valves. However, the outwardly-opening XovrC valve 24, if used in a traditionally shaped port such as that of the prior art split-cycle engine 10 as shown in FIG. 2, has a relatively low discharge coefficient, which consequently decreases the efficiency of the engine by as much as 15%. The low discharge coefficient through the conventional port may have four primary physical causes. The first is the smaller effective flow area that results from the XovrC valve 24 being lifted (outwardly) into the port rather than (inwardly) into the cylinder 12. The second is the sharp direction change required for the compressed air to move around the XovrC valve 24 and into the port. The third is the large-scale turbulence produced behind the head of the XovrC valve 24. As shown in FIG. 3, the XovrC valve 24 causes significant flow separation in the flow stream, with the accompanying large-scale turbulence. Flow separation is the phenomenon that causes large-scale turbulence. Essentially, the boundary layer detaches from the XovrC valve 24 because of the fluid momentum, resulting in a large rotating zone of fluid flow behind the valve. The fourth is the chaotic recombination of the flow streams from all sides of the XovrC valve 24 as they merge into the port (see FIG. 3), which produces smaller-scale turbulence and some pressure loss. The small- and large-scale turbulence in the XovrC valve port results in twisted airflow streamlines in the crossover passage as shown in FIG. 4.

Therefore, a need exists to mitigate these physical phenomena which decrease the efficiency of the engine.

### SUMMARY OF THE INVENTION

The present invention provides a split-cycle engine having an improved crossover compression valve port at a crossover compression valve end of the crossover passage. The unique geometry of the present crossover compression valve port negates the flow losses observed in prior art split-cycle engines having outwardly-opening valves. The present crossover compression valve port thereby improves the efficiency of a split-cycle engine by significantly increasing air flow into and through the crossover passage.

The present invention may be utilized with any split-cycle engine, including air hybrid arrangements such as disclosed in U.S. Pat. Nos. 7,353,786, 7,603,970, and 7,954,462, as well as with any split-cycle engine having a turbocharged downsized compression cylinder as disclosed in U.S. patent application Ser. No. 13/239,917, the disclosures of which are hereby incorporated by reference.

The present crossover compression valve port further may be utilized to improve flow in conventional four-stroke internal combustion engines in which low valve lifts must be used, such as high-speed engines.

An engine valve port in accordance with the invention includes a valve opening, a first portion, and a separate second portion. The first portion and the second portion are separately connected to the valve opening, and the first portion and the second portion merge together at a location spaced from the valve opening.

In one embodiment, a split-cycle engine in accordance with the invention includes a crankshaft rotatable about a crankshaft axis. A compression piston is slidably received within a compression cylinder and operatively connected to the crankshaft such that the compression piston reciprocates through an intake stroke and a compression stroke during a single revolution of the crankshaft. An expansion piston is slidably received within an expansion cylinder and operatively connected to the crankshaft such that the expansion piston reciprocates through an expansion stroke and an exhaust stroke during a single revolution of the crankshaft. A crossover passage interconnects the compression and expansion cylinders. The crossover passage includes a crossover compression (XovrC) valve and a crossover expansion (XovrE) valve defining a pressure chamber therebetween. A XovrC valve inlet at an end of the crossover passage is connected to the compression cylinder. The crossover passage further includes a XovrC valve port at the XovrC valve inlet. The XovrC valve port has a bifurcated, porpoise-like shape including two separate portions that are adjacent to the compression cylinder at the XovrC valve inlet and that merge together downstream from the XovrC valve inlet.

Each of the two portions of the XovrC valve port may be generally arcuate in shape, and each of the two portions of the XovrC valve port may have a generally semicircular cross-section. The XovrC valve associated with the XovrC valve port may be an outwardly-opening valve.

These and other features and advantages of the invention will be more fully understood from the following detailed description of the invention taken together with the accompanying drawings.

### BRIEF DESCRIPTION OF THE DRAWINGS

In the drawings:

FIG. 1 is a cross-sectional view of a prior art split-cycle engine;

FIG. 2 is a perspective view of a crossover compression valve port of a prior art split-cycle engine;

FIG. 3 is a schematic view of air flow through a conventional crossover compression valve port of a prior art split-cycle engine;

FIG. 4 is a schematic view of air flow through a conventional crossover passage of a prior art split-cycle engine;

FIG. 5 is a schematic view of an exemplary embodiment of a crossover passage of a split-cycle engine including a crossover compression valve port in accordance with the present invention;

FIG. 6 is a cross-sectional view of the crossover compression valve port in accordance with the present invention;

FIG. 7 is a three-dimensional perspective cross-sectional view of the crossover compression valve port;

FIG. 8 is a schematic view of air flow through the crossover compression valve port of the split-cycle engine in accordance with the present invention;

FIG. 9 is a schematic view of air flow through the crossover passage of the split-cycle engine in accordance with the present invention;

FIG. 10 is a graphical view illustrating the flow discharge coefficient of a crossover compression valve as a function of valve lift for a conventional crossover compression valve port and for the crossover compression valve port in accordance with the present invention;

FIG. 11 is a graphical view illustrating the flow discharge coefficient of a crossover compression valve as a function of valve lift for an inwardly-opening crossover compression valve and for an outwardly-opening crossover compression valve in the crossover compression valve port in accordance with the present invention;

FIG. 12 is a perspective view of a sand core for casting the crossover compression valve port in accordance with the present invention; and

FIG. 13 is a perspective view of a lower portion of the sand core of FIG. 12.

### DETAILED DESCRIPTION OF THE INVENTION

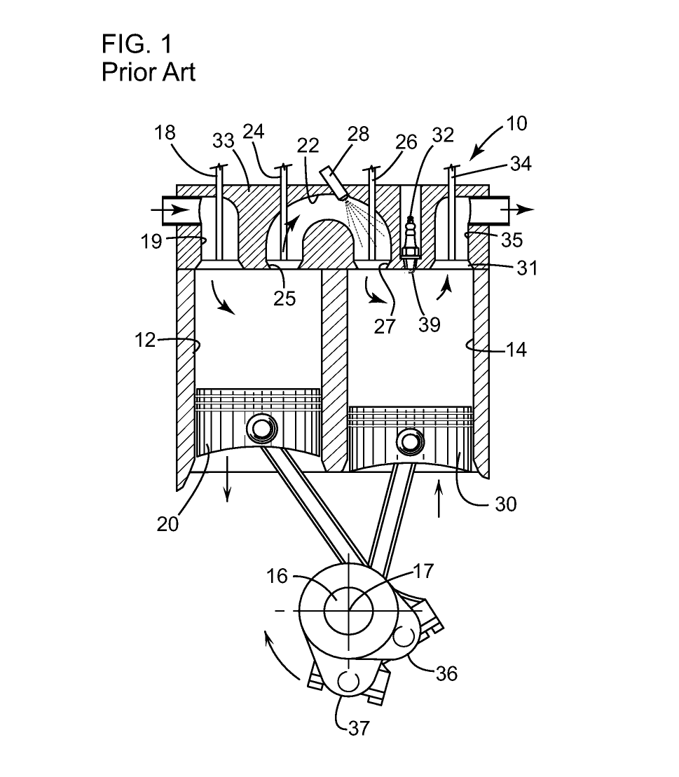

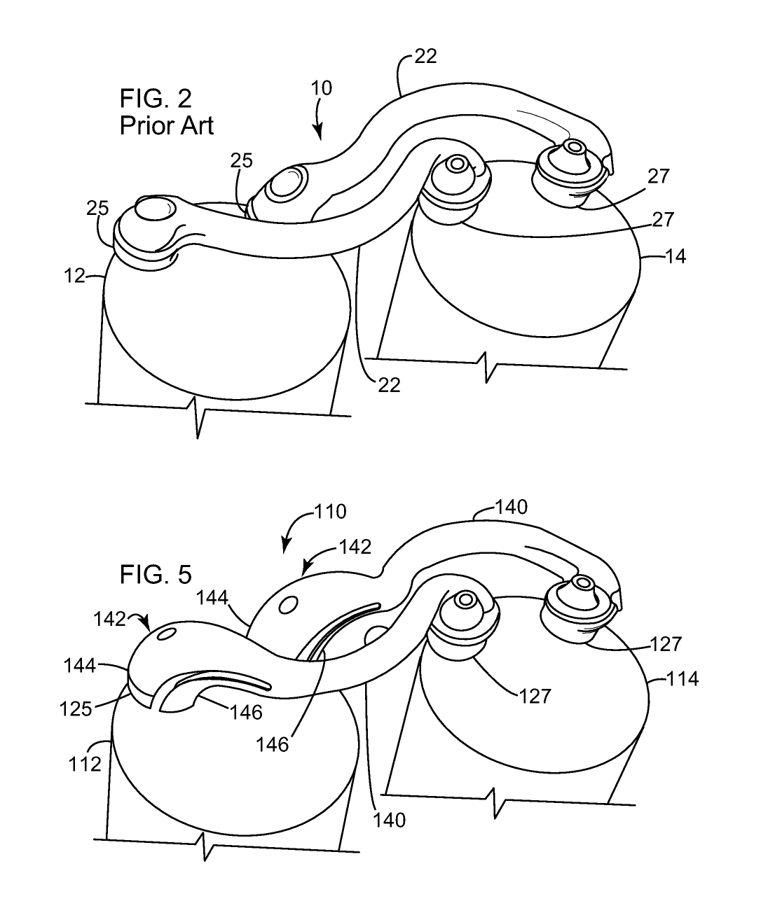

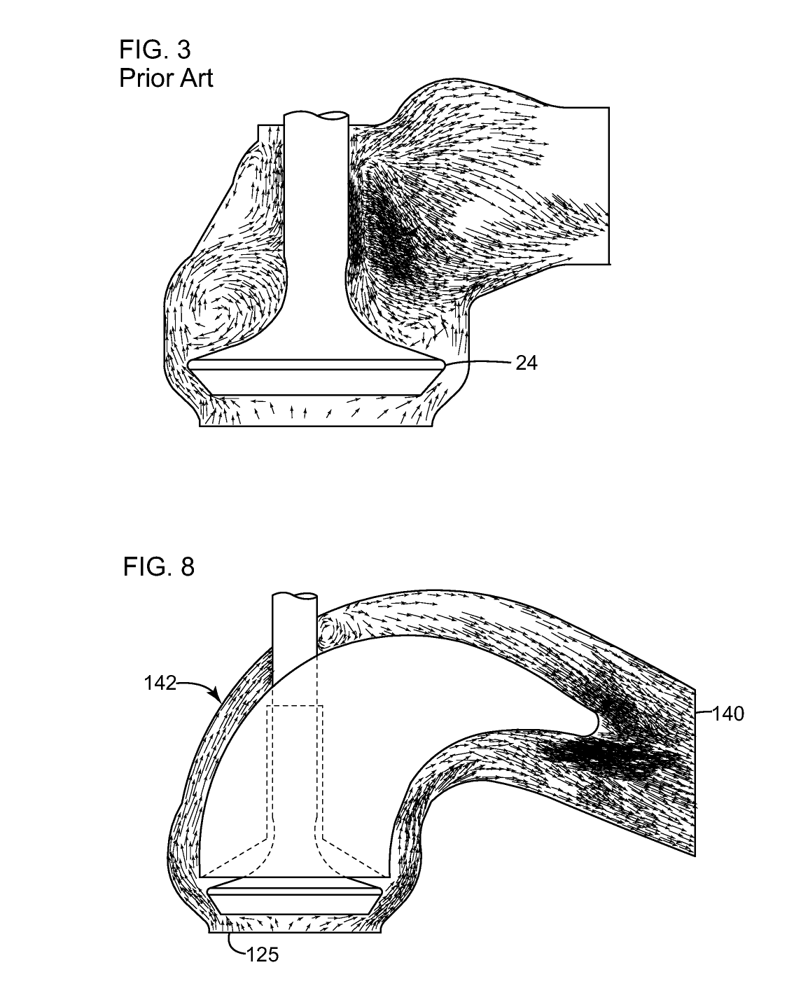

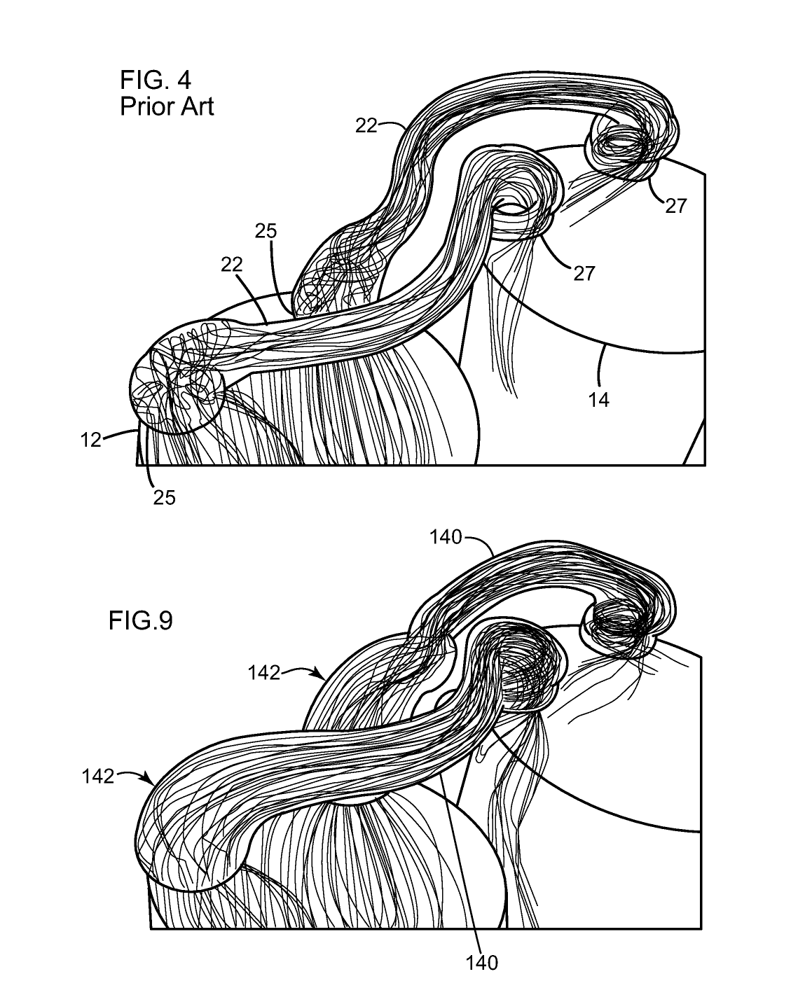

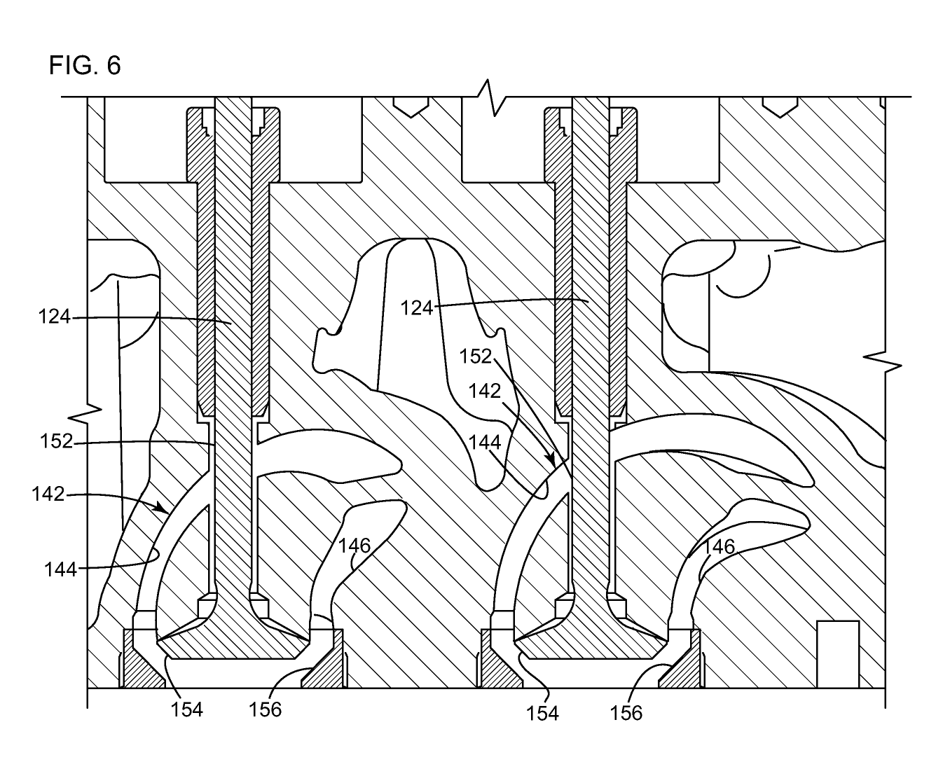

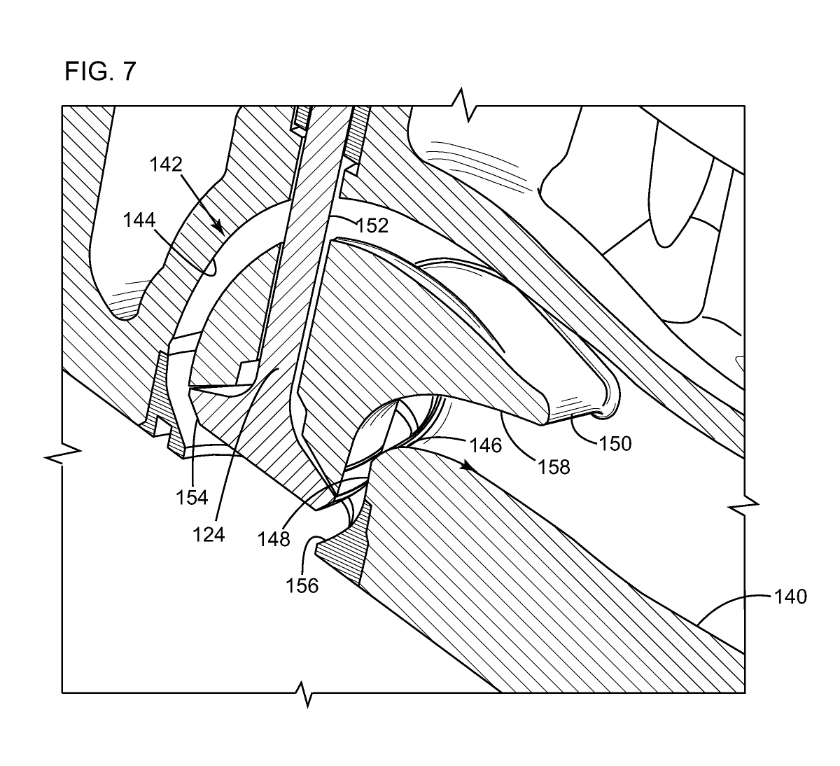

Referring now to FIGS. 5 through 7, the crossover passages of a split-cycle engine 110 in accordance with the invention each includes an improved crossover compression (XovrC) valve port having a bifurcated, porpoise-like shape at the XovrC valve end of the crossover passage. The split-cycle engine 110 may otherwise include the same or similar structure, and may otherwise perform the same or similar function, as the prior art split-cycle engine 10 shown in FIG. 1.

In a specific embodiment, the split-cycle engine 110 includes a compression cylinder 112 and an expansion cylinder 114 connected by at least one crossover passage 140. In the embodiment shown, two crossover passages 140 interconnect the compression and expansion cylinders 112, 114. A XovrC valve inlet 125 is disposed at the end of the crossover passage 140 that is connected to the compression cylinder 112 and a XovrE valve outlet 127 is disposed at the end of the crossover passage that is connected to the expansion cylinder 114. The crossover passage 140 includes the improved XovrC valve port 142 at the XovrC valve inlet 127. The XovrC valve port 142 is split into a first portion 144 and a separate second portion 146 that are adjacent to the compression cylinder 112 at the XovrC valve inlet 125. The first and second portions 144, 146 are generally arcuate in shape and generally have a semicircular cross-section. The first portion 144 is longer in length and has a smoother, more gradual bend in comparison to the second portion 146. The shorter second portion 146 includes a generally straight section 148 at the XovrC valve inlet 125 followed by a nearly 90° bend. The first and second portions 144, 146 merge together into the crossover passage 140 downstream (in the airflow direction) from the XovrC valve inlet 125. The point 150 at which the first and second portions 144, 146 merge is turned generally 90° from the XovrC valve inlet 125.

The XovrC valve 124 includes a valve stem 152 that extends from the poppet head 154 of the valve. The poppet head 154 rests against a valve seat 156 when the valve is in a closed position. The valve stem 152 crosses the first portion 144 of the XovrC valve port 142 and passes into a solid portion 158 that defines the inner wall of the XovrC valve port 142.

The present XovrC valve port 142 eliminates the flow losses observed in the conventional XovrC valve port which were caused by the abrupt direction change, large-scale turbulence, and flow recombination in the conventional port. The present XovrC valve port 142 therefore produces significant flow gains in comparison to the prior art. More specifically, due to the geometry of the present XovrC valve port 142, as compressed air from the compression cylinder 112 contracts to enter the valve curtain area (narrowest path through the valve opening 125 between the valve head 154 and the valve seat 156), it is guided through the bend in the port and gradually expanded over a distance. As shown in FIG. 8, the flow of air (represented by flow velocity vectors) is generally straight (no twisting or swirl) from the opening 125 in the valve through the valve port 142 and into the volume of the crossover passage 140. Thus, as shown in FIG. 9, the air flow streamlines through the XovrC valve port 142 and crossover passage 140 are generally straight, indicating that laminar flow is maintained from the compression cylinder 112 through the crossover passage 140.

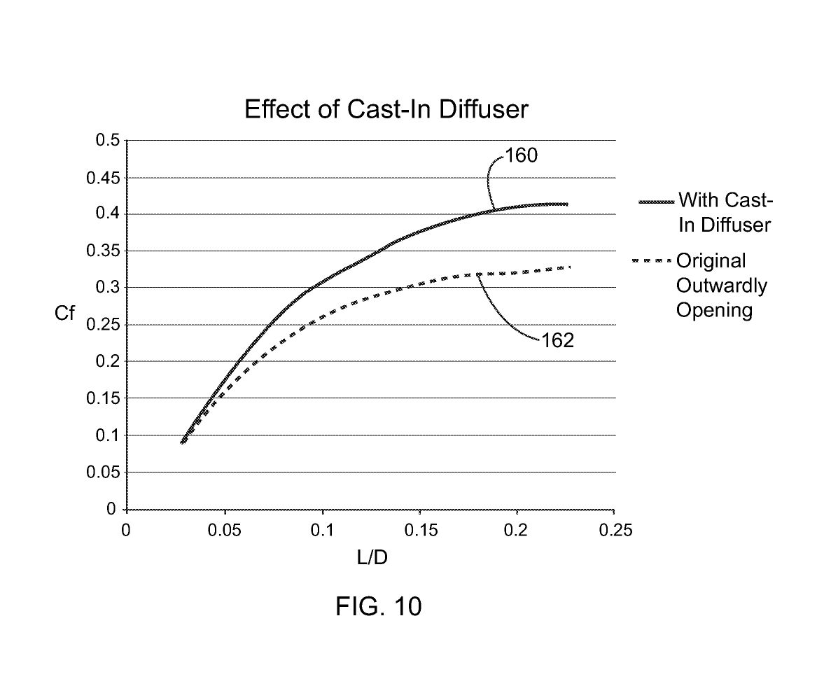

The present XovrC valve port 142 exhibits improved flow characteristics in comparison to conventional arrangements. The flow discharge coefficients of an outwardly-opening XovrC valve 124 in the present XovrC valve port 142 are superior to those of an outwardly-opening valve in a conventional valve port when compared non-dimensionally over a range of valve lifts. In FIG. 10, the flow discharge coefficient (ratio of measured flow to idealized converging/diverging nozzle flow, or more simply the ratio of actual flow rate to theoretical discharge; abbreviated “Cf”) is plotted as a function of L/D (ratio of valve lift to the inner valve seat diameter) for an outwardly-opening valve in the present XovrC valve port (plot 160) and an outwardly-opening valve in a conventional valve port (plot 162), which allows for reasonable comparison of valves of differing size. (Incidentally, the XovrC valve ports in the comparison illustrated in FIG. 10 are the same size.) Based upon steady-state computational fluid dynamics (CFD) and flow testing, the outwardly-opening valve in combination with the present valve port demonstrates superior discharge coefficients at low lifts and beyond. The greater discharge coefficient through the present valve port means that a greater flow of air enters the crossover passage in comparison to the conventional split-cycle engine described above. A greater amount of air flow in turn allows for a greater amount of fuel to be injected into the engine (assuming that a constant, e.g. stoichiometric, air to fuel ratio is maintained), resulting in greater engine torque. This increased engine torque offsets the efficiency losses observed in conventional split-cycle engines.

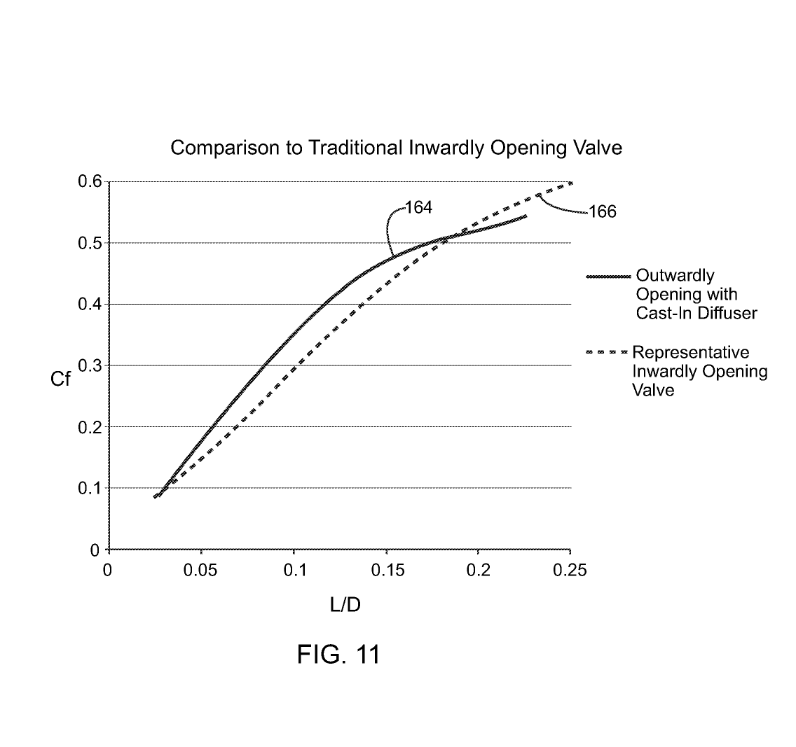

Further, in FIG. 11 the flow discharge coefficient is plotted as a function of L/D for an outwardly-opening valve in the present XovrC valve port (plot 164) and for a representative inwardly-opening valve (plot 166). The outwardly-opening valve in the present valve port similarly outperforms the inwardly-opening valve at low valve lifts (L/D<0.16). The present valve port may therefore have further potential applications in other valve lift-limited engines (i.e., high-speed engines).

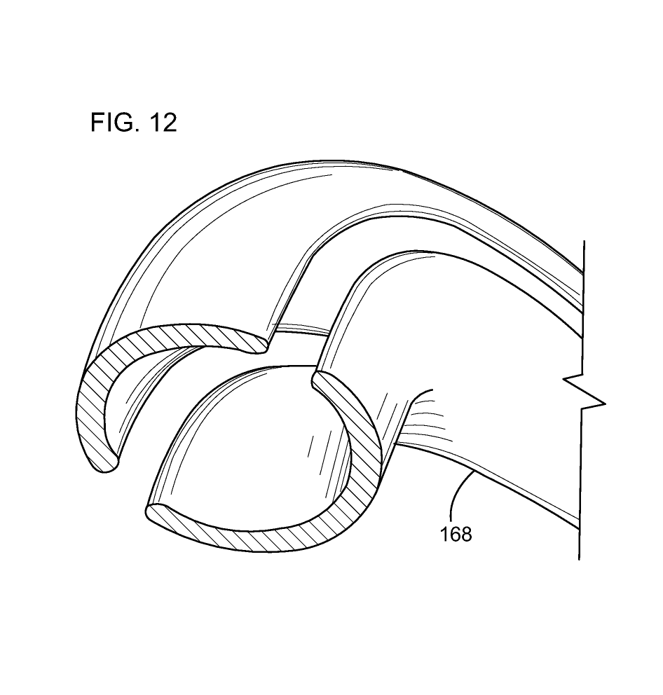

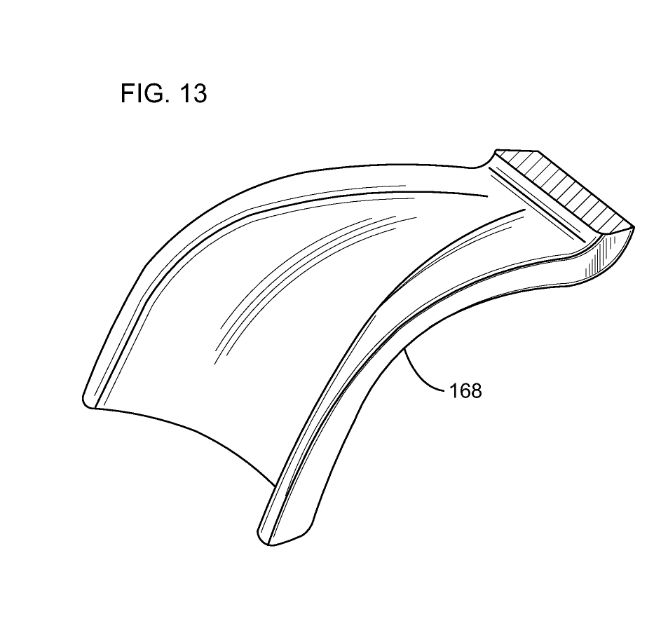

The present XovrC valve port may be manufactured by metal casting, specifically such as by a sand casting process. An example of a portion of a sand core 168 for use in forming the XovrC valve port in the cylinder head casting is shown in FIG. 12, and a lower half of the same sand core 168 is shown in FIG. 13. After casting, the space occupied by the sand core defines the void space of the XovrC valve port through which compressed air travels.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It should also be understood that the invention disclosed and defined herein extends to all alternative combinations of two or more of the individual features mentioned or evident from the text and/or the drawings. All of these different combinations constitute various alternative aspects of the present invention. The embodiments described herein explain the best modes known for practicing the invention and will enable others skilled in the art to utilize the invention.

Although the invention has been described by reference to a specific embodiment, it should be understood that numerous changes may be made within the spirit and scope of the inventive concepts described. Accordingly, it is intended that the invention not be limited to the described embodiment, but that it have the full scope defined by the language of the following claims.

What is claimed is:

1. A split-cycle engine comprising:
a crankshaft rotatable about a crankshaft axis;
a compression piston slidably received within a compression cylinder and operatively connected to the crankshaft such that the compression piston reciprocates through an intake stroke and a compression stroke during a single revolution of the crankshaft;
an expansion piston slidably received within an expansion cylinder and operatively connected to the crankshaft such that the expansion piston reciprocates through an expansion stroke and an exhaust stroke during a single revolution of the crankshaft;
a crossover passage interconnecting the compression and expansion cylinders, the crossover passage including a crossover compression (XovrC) valve and a crossover expansion (XovrE) valve defining a pressure chamber therebetween; and
a XovrC valve inlet at an end of the crossover passage connected to the compression cylinder;
the crossover passage further including a XovrC valve port at the XovrC valve inlet;
the XovrC valve port having a bifurcated, porpoise-like shape, wherein the XovrC valve port includes two separate portions that are adjacent to the compression cylinder at the XovrC valve inlet and that merge together downstream from the XovrC valve inlet.

2. The split-cycle engine of claim 1, wherein the XovrC valve is an outwardly-opening valve.

3. The split-cycle engine of claim 1, wherein each of the two portions of the XovrC valve port is generally arcuate in shape.

4. The split-cycle engine of claim 1, wherein each of the two portions of the XovrC valve port has a generally semicircular cross-section.

5. The split-cycle engine of claim 1, wherein air flow through the XovrC valve port and the crossover passage is generally laminar.

6. The split-cycle engine of claim 1, wherein the XovrC valve port increases air flow into and through the crossover passage, thereby improving the efficiency of the split-cycle engine.

7. An engine comprising:
an engine cylinder;
a passage connected to the engine cylinder and communicating with the engine cylinder through an opening;
a valve controlling fluid communication between the engine cylinder and the passage; and
a valve port associated with the valve and disposed in the passage at the opening;
the valve port having a bifurcated, porpoise-like shape, wherein the valve port includes two separate portions that are adjacent to the cylinder at the valve opening and that merge together at a location spaced from the valve opening.

8. The engine of claim 7, wherein the valve is an outwardly-opening valve.

9. The engine of claim 7, wherein each of the two portions of the valve port is generally arcuate in shape.

10. The engine of claim 7, wherein each of the two portions of the valve port has a generally semicircular cross-section.

11. An engine valve port comprising:
a valve opening; and
a first portion and a separate second portion, each of the first portion and the second portion being separately connected to the valve opening;
the first portion and the second portion merging together at a location spaced from the valve opening.

12. The valve port of claim 11, wherein the valve port has a bifurcated, porpoise-like shape.

13. The valve port of claim 11, wherein the first portion and the second portion are generally arcuate in shape.

14. The engine of claim 11, wherein the first portion and the second portion have a generally semicircular cross-section.

15. An engine including the valve port of claim 11.
